(19) United States
(12) Patent Application Publication
(10) Pub. No.: US 2025/0261617 A1
(43) Pub. Date: Aug. 21, 2025

(54) Integrated Retractable Leash Dog Harness Device

(71) Applicant: Katie Rivera, Eagle, CO (US)

(72) Inventor: Katie Rivera, Eagle, CO (US)

(21) Appl. No.: 19/013,508

(22) Filed: Jan. 8, 2025

Related U.S. Application Data
(60) Provisional application No. 63/555,934, filed on Feb. 21, 2024.

(51) Int. Cl. A01K 27/00

(52) U.S. Cl. CPC A01K 27/002; A01K 27/004

(57) ABSTRACT

An integrated retractable leash dog harness device is provided. The device is comprised of a harness body that is designed to fit around the torso of an animal and includes primary and secondary adjustable straps for securing the device around the neck and torso of the animal. The body further comprises a housing containing a spring-loaded reel for retracting a leash into the housing when not in use. The leash can be extended via a handle that may include attachment points for accessories like waste bag dispensers. In some embodiments, the body or housing may include pockets for storing waste bags and a clip may be used to secure the leash or create a secondary handle.

### CROSS-REFERENCE TO RELATED APPLICATION

The present application claims priority to, and the benefit of, U.S. Provisional Application No. 63/555,934, which was filed on Feb. 21, 2024, and is incorporated herein by reference in its entirety.

### FIELD OF THE INVENTION

The present invention relates generally to the field of dog harnesses. More specifically, the present invention relates to an integrated retractable leash dog harness device comprised of a dog harness with an integrated retractable leash that retracts into the harness when not in use. Accordingly, the present disclosure makes specific reference thereto. Nonetheless, it is to be appreciated that aspects of the present invention are also equally applicable to other like applications, devices, and methods of manufacture.

### BACKGROUND

Many dog owners enjoy the freedom and joy of letting their dogs roam off-leash, allowing their pets to explore the surroundings, run, and play with a sense of independence. Off-leash adventures give dogs a chance to burn off energy and engage with their environment in a more natural way, which can be both mentally stimulating and physically beneficial for the dog. However, this freedom often comes with a set of challenges. There are moments when a leash is suddenly necessary, whether it's due to local leash laws, encountering other people and animals, or navigating through high-traffic areas. In these situations, owners are often forced to scramble to find and attach a leash quickly.

This can become an annoying hassle, especially if the leash is buried in a bag or pocket, or if the dog is overly excited and difficult to manage in the moment. Fumbling with a leash while trying to regain control of an energetic dog can be frustrating and stressful, turning what should be a carefree outing into a source of tension. For many, the inconvenience of carrying a leash and having to repeatedly clip it on and off takes away from the spontaneity and enjoyment of spending time outdoors with their dogs. This can lead to a feeling of being unprepared or hindered during an otherwise pleasant experience, making leash handling a common yet cumbersome task for many dog owners.

Therefore, there exists a long-felt need in the art for an improved dog leash. There also exists a long-felt need in the art for an integrated retractable leash dog harness device. More specifically, there exists a long-felt need in the art for an integrated retractable leash dog harness device that provides an easily accessible dog leash. Further, there exists a long-felt need in the art for an integrated retractable leash dog harness device that provides an easily accessible dog leash that can be stored when not in use.

The subject matter disclosed and claimed herein, in one embodiment thereof, comprises an integrated retractable leash dog harness device. The device is comprised of a harness body that is designed to fit around the torso of an animal and includes primary and secondary adjustable straps for securing the device around the neck and torso of the animal. The body further comprises a housing containing a spring-loaded reel for retracting a leash into the housing when not in use. The leash can be extended via a handle that may include attachment points for accessories like waste bag dispensers. In some embodiments, the body or housing may include pockets for storing waste bags and a clip may be used to secure the leash or create a secondary handle.

In this manner, the integrated retractable leash dog harness device of the present invention accomplishes all the foregoing objectives and provides an improved dog leash. More specifically, the device provides a dog harness with an integrated retractable leash that provides an easily accessible dog leash. Further, the leash can be stored within the harness when not in use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an integrated retractable leash dog harness device comprised of a body that surrounds the upper body/torso area of an animal such as, but not limited to, a dog.

The body is comprised of at least one primary strap that preferably surrounds the neck of the animal wearing the device. The primary strap is preferably adjustable via at least one adjustment fastener such as, but not limited to, a sliding buckle fastener. The strap may also be comprised of a securing fastener that secures the strap at a desired length. The body is comprised of at least one secondary strap that preferably surrounds the torso of the animal wearing the device. The secondary strap is preferably adjustable via at least one adjustment fastener such as, but not limited to, a sliding buckle fastener. The strap may also be comprised of a securing fastener that secures the strap at a desired length.

The body is also comprised of at least one comprised of at least one reel. The reel is preferably a spring-loaded reel that receives at least one leash. The reel may be a locking reel that allows the leash to be locked at a desired length via manipulating the reel via the leash. When not in use, the leash remains wound around the reel within the housing. When in use, the leash can be pulled from the housing and unwound from around the reel via at least one handle.

In one embodiment, the device is comprised of a handle clip. The clip may be fixedly attached to the leash and/or handle, wherein the leash can then be secondarily attached to a receiving point of the clip, such as, but not limited to, a groove, a clip, etc. This allows the leash to be looped over itself to form a secondary handle. The clip may also be used as a fastener which attaches to the housing to secure the leash within the housing.

The present invention is also comprised of a method of using the device. First, a device is provided comprised of a harness body comprised of a primary strap comprised of a first securing fastener, a secondary strap comprised of a second securing fastener, a housing comprised of a reel wherein a leash is attached to the reel, and a handle attached to the leash. Then, the body can be secured around the neck and the torso of an animal via securing the primary strap and secondary strap around the neck and torso of the animal via the fasteners. Next, the leash can be pulled from the housing via the handle and used to walk the animal. Finally, the leash can be retracted back into the housing around the reel via releasing the leash.

Accordingly, the integrated retractable leash dog harness device of the present invention is particularly advantageous as it provides an improved dog leash. More specifically, the device provides an easily accessible dog leash. Further, the device provides an easily accessible dog leash that can be stored when not in use. In this manner, the integrated retractable leash dog harness device overcomes the limitations of existing dog leashes known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an integrated retractable leash dog harness device of the present invention with a retracted leash in accordance with the disclosed architecture;

FIG. 2 illustrates a perspective view of one potential embodiment of an integrated retractable leash dog harness device of the present invention with an extended leash and wherein the device is worn by an animal in accordance with the disclosed architecture;

FIG. 3 illustrates an enhanced perspective view of one potential embodiment of a leash of an integrated retractable leash dog harness device of the present invention with an extended leash in accordance with the disclosed architecture; and

FIG. 4 illustrates a flowchart of a method of using one potential embodiment of an integrated retractable leash dog harness device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved dog leash. There also exists a long-felt need in the art for an integrated retractable leash dog harness device. More specifically, there exists a long-felt need in the art for an integrated retractable leash dog harness device that provides an easily accessible dog leash. Further, there exists a long-felt need in the art for an integrated retractable leash dog harness device that provides an easily accessible dog leash that can be stored when not in use.

The present invention, in one exemplary embodiment, is comprised of an integrated retractable leash dog harness device comprised of a body that surrounds the upper body/torso area of an animal such as, but not limited to, a dog. The body is comprised of at least one primary strap that preferably surrounds the neck of the animal wearing the device. The primary strap is preferably adjustable via at least one adjustment fastener such as, but not limited to, a sliding buckle fastener. The strap may also be comprised of a securing fastener that secures the strap at a desired length. The body is comprised of at least one secondary strap that preferably surrounds the torso of the animal wearing the device. The secondary strap is preferably adjustable via at least one adjustment fastener such as, but not limited to, a sliding buckle fastener. The strap may also be comprised of a securing fastener that secures the strap at a desired length.

The body is also comprised of at least one comprised of at least one reel. The reel is preferably a spring-loaded reel that receives at least one leash. The reel may be a locking reel that allows the leash to be locked at a desired length via manipulating the reel via the leash. When not in use, the leash remains wound around the reel within the housing. When in use, the leash can be pulled from the housing and unwound from around the reel via at least one handle.

In one embodiment, the device is comprised of a handle clip. The clip may be fixedly attached to the leash and/or handle, wherein the leash can then be secondarily attached to a receiving point of the clip, such as, but not limited to, a groove, a clip, etc. This allows the leash to be looped over itself to form a secondary handle. The clip may also be used as a fastener which attaches to the housing to secure the leash within the housing.

The present invention is also comprised of a method of using the device. First, a device is provided comprised of a harness body comprised of a primary strap comprised of a first securing fastener, a secondary strap comprised of a second securing fastener, a housing comprised of a reel wherein a leash is attached to the reel, and a handle attached to the leash. Then, the body can be secured around the neck and the torso of an animal via securing the primary strap and secondary strap around the neck and torso of the animal via the fasteners. Next, the leash can be pulled from the housing via the handle and used to walk the animal. Finally, the leash can be retracted back into the housing around the reel via releasing the leash.

Accordingly, the integrated retractable leash dog harness device of the present invention is particularly advantageous as it provides an improved dog leash. More specifically, the device provides an easily accessible dog leash. Further, the device provides an easily accessible dog leash that can be stored when not in use. In this manner, the integrated retractable leash dog harness device overcomes the limitations of existing dog leashes known in the art.

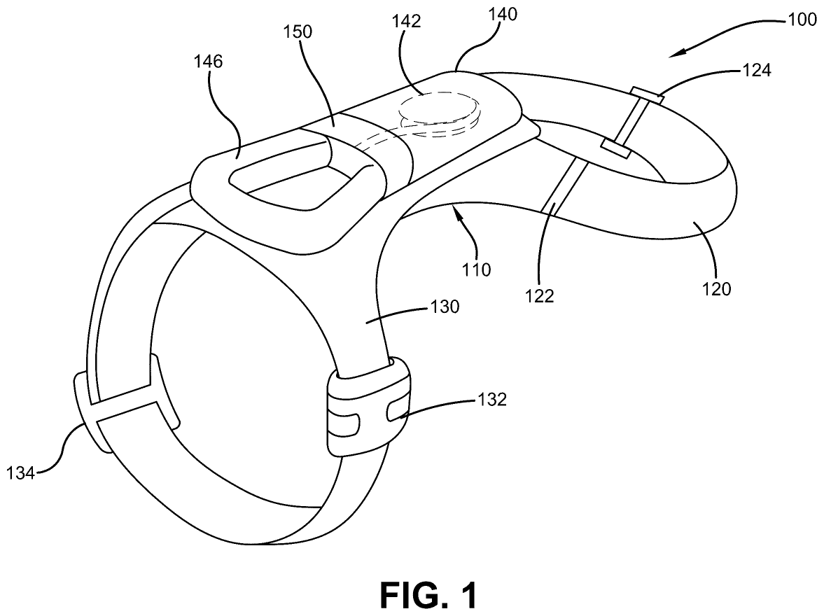

Referring initially to the drawings, FIG. 1 illustrates a perspective view of one potential embodiment of an integrated retractable leash dog harness device 100 of the present invention with a retracted leash 144 in accordance with the disclosed architecture. The device 100 is comprised of a body 110. The body 110 may be comprised of any pet harness material such as, but not limited to, a fabric material such as, but not limited to, a nylon, a polyester, a mesh, a leather, a neoprene, a cotton, a reflective material, etc. The body 110 may be any size and shape to surround the upper body/torso area of an animal such as, but not limited to, a dog.

The body 110 is comprised of at least one primary strap 120. The primary strap 120 preferably surrounds the neck of the animal wearing the device 100. The primary strap 120 is preferably adjustable via at least one adjustment fastener 124 such as, but not limited to, a sliding buckle fastener. The strap 120 may also be comprised of a securing fastener 122 that secures the strap 120 at a desired length. The fastener 122 may include, but is not limited to, a buckle, a snap button, a hook and loop fastener, a magnetic fastener, a button, and opening fastener, etc.

The body 110 is comprised of at least one secondary strap 130. The secondary strap 130 preferably surrounds the torso of the animal wearing the device 100. The secondary strap 130 is preferably adjustable via at least one adjustment fastener 134 such as, but not limited to, a sliding buckle fastener. The strap 130 may also be comprised of a securing fastener 132 that secures the strap 130 at a desired length. The fastener 132 may include, but is not limited to, a buckle, a snap button, a hook and loop fastener, a magnetic fastener, a button, and opening fastener, etc.

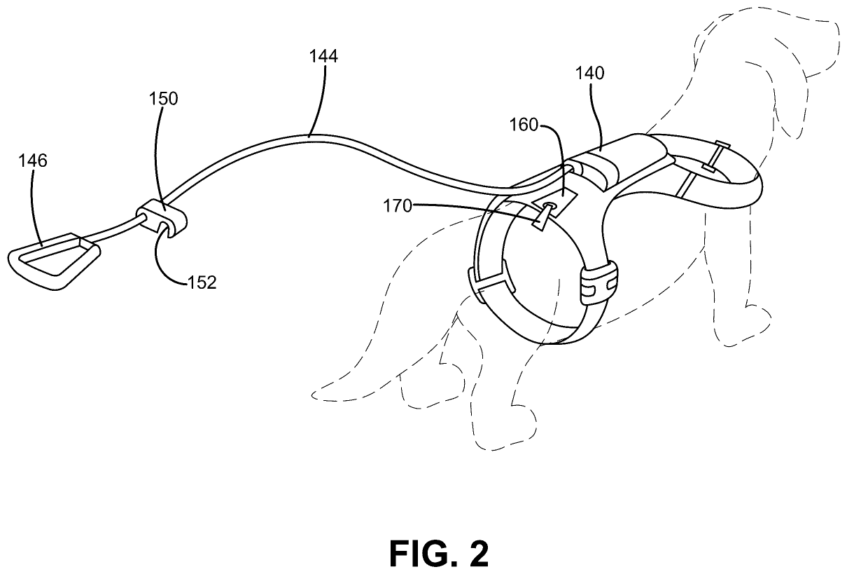

The body 110 is also comprised of at least one housing 140. The housing 140 is comprised of at least one reel 142. The reel 142 is preferably a spring-loaded reel that receives at least one leash 144. The reel 142 may be a locking reel that allows the leash 144 to be locked at a desired length via manipulating the reel 142 via the leash 144. The leash 144 is preferably made from a durable metal, plastic, or fabric material. When not in use, the leash 144 remains wound around the reel 142 within the housing 140. When in use, the leash 144 can be pulled from the housing 140 and unwound from around the reel 142 via at least one handle 146. The handle 146 may be any style of leash handle known in the art. The handle 146 may be comprised of at least one attachment point 148 such as, but not limited to, a clip that allows an accessory to be attached to the handle 146, such as, but not limited to, a dog waste bag dispenser. In a different embodiment, the body 110 and/or housing 140 may be comprised of at least one pocket 160 that can receive waste bags 170 as seen in FIG. 2, wherein bags 170 can be pulled from the pocket 160 as needed.

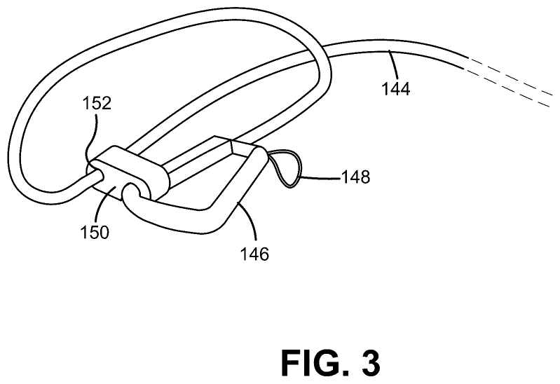

In one embodiment, the device 100 is comprised of a handle clip 150, as seen in FIG. 3. The clip 150 may be fixedly attached to the leash 144 and/or handle 146, wherein the leash 144 can then be secondarily attached to a receiving point 152 of the clip 150, such as, but not limited to, a groove, a clip, etc. This allows the leash 144 to be looped over itself to form a secondary handle. The clip 150 may also be used as a fastener which attaches to the housing 140 to secure the leash 144 within the housing.

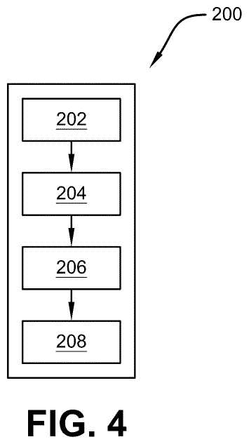

The present invention is also comprised of a method of using 200 the device 100, as seen in FIG. 4. First, a device 100 is provided comprised of a harness body 110 comprised of a primary strap 120 comprised of a first securing fastener 122, a secondary strap 130 comprised of a second securing fastener 132, a housing 140 comprised of a reel 142 wherein a leash 144 is attached to the reel 142, and a handle 146 attached to the leash 144 [Step 202]. Then, the body 110 can be secured around the neck and the torso of an animal via securing the primary strap 120 and secondary strap 130 around the neck and torso of the animal via the fasteners 122, 132 [Step 204]. Next, the leash 144 can be pulled from the housing 140 via the handle 146 and used to walk the animal [Step 206]. Finally, the leash 144 can be retracted back into the housing 140 around the reel 142 via releasing the leash 144 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “integrated retractable leash dog harness device” and “device” are interchangeable and refer to the integrated retractable leash dog harness device 100 of the present invention.

Notwithstanding the foregoing, the integrated retractable leash dog harness device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the integrated retractable leash dog harness device 100 as shown in the FIGS. are for illustrative purposes only, and that many other sizes and shapes of the integrated retractable leash dog harness device 100 are well within the scope of the present disclosure. Although the dimensions of the integrated retractable leash dog harness device 100 are important design parameters for user convenience, the integrated retractable leash dog harness device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An integrated retractable leash dog harness device comprising:
a harness body comprised of:
an adjustable length strap comprised of a fastener;
a housing comprised of a spring-loaded reel; and
a leash attached to the reel, the leash comprised of a handle.

2. The integrated retractable leash dog harness device of claim 1, wherein the body is comprised of a reflective fabric material.

3. The integrated retractable leash dog harness device of claim 1, wherein the fastener is comprised of a buckle, a snap button, a hook and loop fastener, a magnetic fastener, or a button and opening fastener.

4. The integrated retractable leash dog harness device of claim 1, wherein the leash is comprised of a metal or a plastic material.

5. An integrated retractable leash dog harness device comprising:
a harness body comprised of:
a primary strap comprised of a first securing fastener and a first adjustment fastener;
a secondary strap comprised of a second securing fastener and a second adjustment fastener;
a housing comprised of a spring-loaded reel; and
a leash attached to the reel, the leash comprised of a handle and a clip.

6. The integrated retractable leash dog harness device of claim 5, wherein the first securing fastener and the second securing fastener are comprised of a buckle, a snap button, a hook and loop fastener, a magnetic fastener, or a button and opening fastener.

7. The integrated retractable leash dog harness device of claim 5, wherein the first adjustment fastener and the second adjustment fastener are comprised of a sliding buckle.

8. The integrated retractable leash dog harness device of claim 5, wherein the leash is comprised of a metal or a plastic material.

9. The integrated retractable leash dog harness device of claim 5, wherein the handle is comprised of an attachment point comprised of a clip.

10. The integrated retractable leash dog harness device of claim 5, wherein the body is comprised of a pocket.

11. The integrated retractable leash dog harness device of claim 10, wherein the pocket receives a waste bag.

12. The integrated retractable leash dog harness device of claim 5 further comprised of a handle clip.

13. The integrated retractable leash dog harness device of claim 12, wherein the handle clip is fixedly attached to the leash.

14. The integrated retractable leash dog harness device of claim 13, wherein the handle clip is comprised of a receiving point.

15. The integrated retractable leash dog harness device of claim 5, wherein the body is comprised of a nylon, a polyester, a mesh, a leather, a neoprene, a cotton, or a reflective material.

16. A method of using an integrated retractable leash dog harness device, the method comprising the following steps:
providing an integrated retractable leash dog harness device comprised of a harness body comprised of a primary strap comprised of a first securing fastener, a secondary strap comprised of a second securing fastener, a housing comprised of a reel wherein a leash is attached to the reel, and a handle attached to the leash;
securing the body around the neck and the torso of an animal via securing the primary strap and secondary strap around the neck and torso of the animal via the fasteners;
pulling the leash from the housing via the handle and using the leash to walk the animal; and
retracting the leash back into the housing.

17. The method of using an integrated retractable leash dog harness device of claim 16, wherein the first securing fastener is comprised of a buckle, a snap button, a hook and loop fastener, a magnetic fastener, or a button and opening fastener.

18. The method of using an integrated retractable leash dog harness device of claim 16, wherein the second securing fastener is comprised of a buckle, a snap button, a hook and loop fastener, a magnetic fastener, or a button and opening fastener.

19. The method of using an integrated retractable leash dog harness device of claim 16, wherein the reel is positioned within the housing.

20. The method of using an integrated retractable leash dog harness device of claim 16, wherein the leash is comprised of a clip.
